(19) United States
(12) Patent Application Publication
(10) Pub. No.: US 2009/0183360 A1
(43) Pub. Date: Jul. 23, 2009

(54) Domestic appliance combination

(75) Inventors: Robert Hasslberger, Ruhpolding (DE); Juergen Schuchhardt, Elmshorn (DE); Nesrin Schuchhardt, Elmshorn (DE); Markus Theine, Freilassing (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeraete GmbH, Muenchen (DE)

(21) Appl. No.: 12/077,292

(22) Filed: Mar. 18, 2008

(30) Foreign Application Priority Data
Mar. 20, 2007 (DE) 10 2007 013 318.0

(51) Int. Cl. B23P 19/04

(52) U.S. Cl. 29/700

(57) ABSTRACT

A domestic appliance combination comprising at least a first domestic appliance and a second domestic appliance arranged thereabove is disclosed, these being connected to one another for installation into a common built-in housing, with the second domestic appliance being connected to the first domestic appliance by means of a clamp-connection. A method for connecting at least two domestic appliances one above the other is also disclosed, which comprises a step involving fastening the second domestic appliance by means of a clamp-connection.

The invention relates to two domestic appliance combinations and method for connecting two domestic appliances.

Certain domestic appliances, e.g. a refrigerator and a freezer were previously conventionally connected by means of screws and then inserted into a common built-in housing.

However, ovens which are arranged one above the other, between which a heat decoupling is conventionally desired, were hitherto combined such that two ‘complete’ devices—i.e., with their own built-in housing, are connected to one another by way of fixed connections such as screw joints, welded joints, bolts etc. The respective built-in housings together with the air duct afforded thereby provide the desired heat decoupling. However, such a solution requires a comparatively large amount of installation space, is expensive in terms of assembly and is comparatively time-consuming in terms of maintenance and repairs.

It is thus an object of the present invention to provide a comparatively compact domestic appliance combination, which is simple to assemble, cost-effective and provides as uniform an exterior design as possible. The domestic appliance combination should advantageously also be able to provide a possibility for heat decoupling in the domestic appliances.

This object is achieved by a domestic appliance combination as claimed in claim 1 or 6 and a method as claimed in claim 8. Advantageous embodiments can be inferred in particular from the subclaims alone or in combination therewith.

The object is achieved by a domestic appliance combination comprising at least one first domestic appliance and second domestic appliance arranged thereabove, which are connected to one another for installation in a common built-in housing, with the second domestic appliance being connected to the first domestic appliance by means of a clamp-connection. A screwing step can be dispensed with as a result of the clamp-connection, thereby simplifying assembly. In case a service call is required (e.g. maintenance or repair), a clamp-connection can frequently be easily released and reassembled with a few manual operations so that the upper domestic appliance can be easily removed, namely either for its repair/maintenance or to provide access to the first domestic appliance. Installation in a common built-in housing produces a compact construction particularly for ovens.

It is advantageous for the simple constructive realization and operation for the clamp-connection to include a clamping bracket disposed on the second domestic appliance.

It is also advantageous if a support construction is present between the first domestic appliance and the second domestic appliance, said support construction being supported by the first domestic appliance and supporting the second domestic appliance. A heat decoupling can be assisted for instance and vibrations etc. can also be decoupled. The clamp-connection can connect the first and second domestic appliance directly, e.g. by attachment to side panels of the first domestic appliance. It is however advantageous if the clamp-connection is mounted on the support construction and thus indirectly connects the first domestic appliance to the second domestic appliance.

It is particularly advantageous for compact heat decoupling if the support construction forms at least one part of an air channel of the second domestic appliance.

It is advantageous for the cooling process if air channels are mounted on the second domestic appliance.

It is advantageous, particularly for an oven combination comprising especially an oven and a microwave oven arranged thereabove, if these are set up for installation into a common built-in housing. This represents an independent inventive point of view for ovens.

It is also advantageous if the domestic appliance combination is built into a common built-in housing.

The invention is also achieved by a method for connecting at least two domestic appliances one on top of the other, which has a step which involves fastening the second domestic appliance by means of a clamp-connection.

The following steps advantageously precede the fastening step: attaching a support construction to the first domestic appliance, which is set up to accommodate the second domestic appliance; and attaching the second domestic appliance to the support construction; with the fastening step involving fastening the second domestic appliance to the support construction by means of the clamp-connection.

The method is particularly advantageous if it also includes the step of inserting the domestic appliance into a common built-in housing.

The invention is described schematically in more detail below with reference to an exemplary embodiment. The exemplary embodiment is not to be regarded here as restrictive for the invention. Identical or identically-functioning parts are continuously provided with the same reference characters.

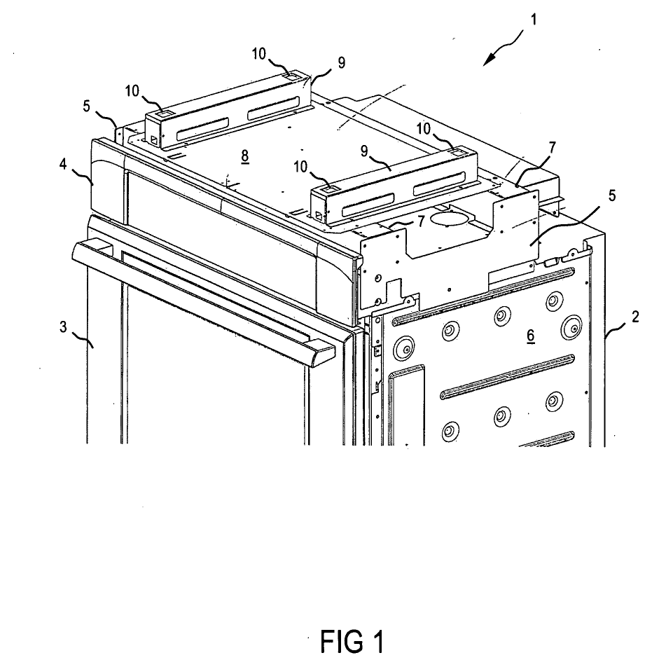

FIG. 1 shows a domestic appliance combination in a first assembly stage inclined obliquely to the right in front.

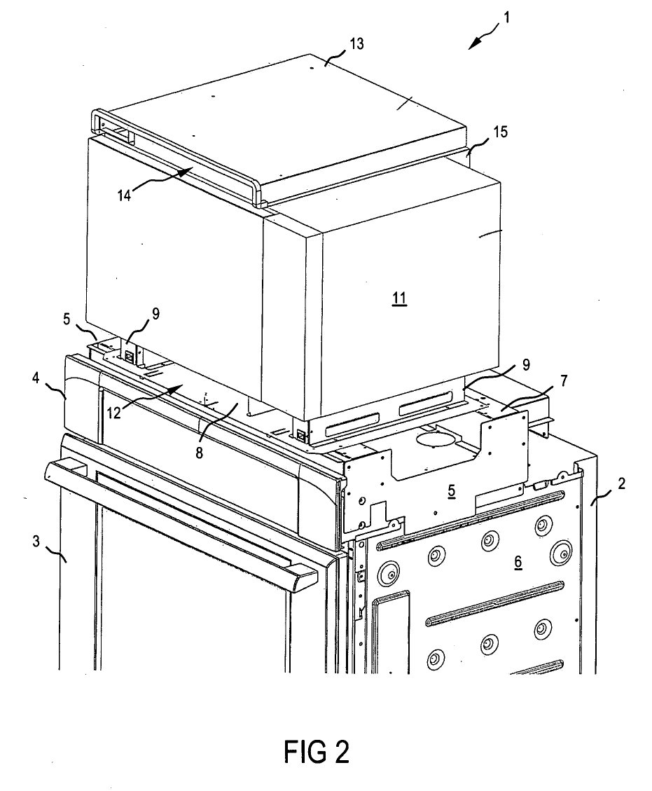

FIG. 2 shows the domestic appliance combination of FIG. 1 in a more advanced assembly stage.

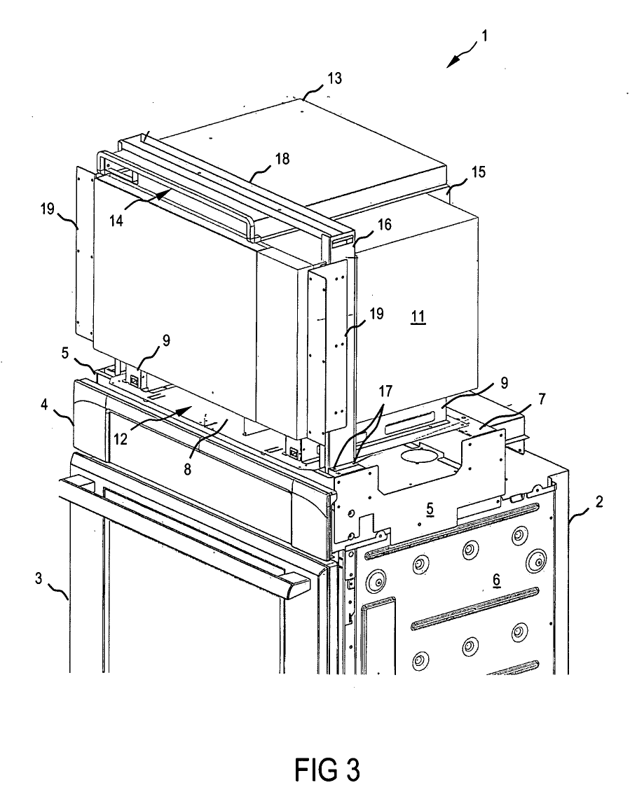

FIG. 3 shows the domestic appliance combination of FIG. 2 in an even more advanced assembly stage.

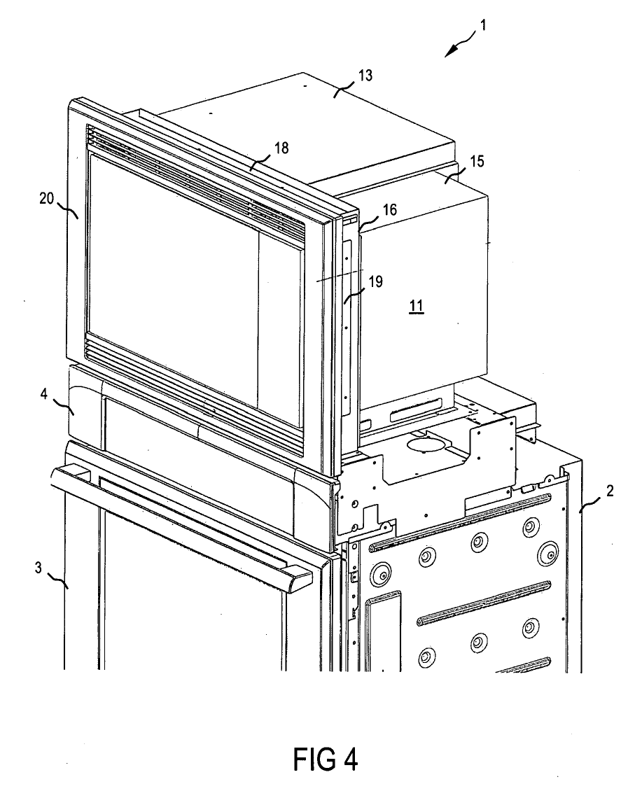

FIG. 4 shows the domestic appliance combination of FIG. 1 in a completed preassembled assembly stage.

FIG. 1 shows an oven 2 of a domestic appliance combination 1 obliquely from the front right, which is provided for installation into built-in housing (not shown), namely in a first assembly stage of the preassembly of support parts. The oven 2 has an oven door 2 on the front side, above which a panel 4 is arranged. A gusset plate 5 is arranged on the side of the oven 2 in each instance, which is set up to control a weight acting thereupon into a wall of the oven 2, here a side panel 6 arranged therebelow. The gusset plates 5 are connected by means of two cross arms 7, on which a lower air baffle 8 is disposed for the microwave to be mounted above the oven. Support profiles 9 for supporting the microwave to be mounted are disposed on the lower air baffle 8 extending from the front to the back. The support profiles 9 can be produced separately or can be produced at least partially in one piece with the air baffle 8. The support profiles 9 have recesses 10 for the feet of the microwave. The gusset plate 5, the cross arms 7 and the support profiles 9 thus represent a support structure, which distances the microwave to be mounted from the oven 2. The panel 4 covers this support structure and can be regarded as being a part thereof. Alternatively, the panel can comprise display and control elements of one of both devices.

FIG. 2 shows the domestic appliance combination 1 in a view which is similar to that in FIG. 1 in a further assembly stage with a microwave 11, which is disposed on the support profile 9 such that its feet fit into the recesses, as a result of which the microwave 11 is arranged on the oven 2. As the support profiles 9 distance the lower wall of the microwave 11 from the lower air baffle 8, a lower guide channel 12 is herewith created over essentially the entire width of the microwave 11. An upper air baffle 13 is also distanced from an upper device wall of the microwave 11, as a result of which an upper air guide channel is created over essentially the entire width of the microwave 11. In addition, a rear air baffle 15 is mounted at a distance from a rear device wall of the microwave 11, as a result of which a rear air guide channel (not shown) is created over essentially the entire width of the microwave 11. The air channels produce an adequate cooling air volume to cool the device walls.

FIG. 3 shows the domestic appliance combination 1 in a view similar to that in FIGS. 1 and 2 in a further assembly stage, in which the microwave 11 is only clamped for fastening purposes. To this end, a left-hand and right-hand bracket 16 are fastened to the front cross arm by way of screw-connection points 17 (two per side), such that they run laterally up the microwave 11 in each instance and extend beyond its top side. The left-hand and right-hand brackets 16 have slotted recesses (without reference characters) in an upper region, by means of which an upper clamping bracket 18 is engaged. In this way, the upper clamping bracket 18 is on the topside of the microwave 11 under tension such that it presses this against the support profile 9. A clamping fixture is thus created for the microwave 11 by the brackets 16, 18. This fixture can be easily opened, particularly without releasing a screw connection and subsequently the microwave 11 can be easily assembled and reassembled.

In an alternative embodiment, the right and left brackets can also be engaged or locked in an associated support part and/or base, such as for instance a cross arm, instead of being attached by screwing for instance. A screwing step is herewith saved during the assembly, however assembly and maintenance are as such more difficult to manage.

Two or even more bracket fixtures 16, 18 can also be used.

A frame holder 19 is attached to the outside of the bracket 16 in each instance, which is provided to attach a decor frame (see FIG. 4).

FIG. 4 shows the domestic appliance combination from the FIGS. 1 to 3 in a completed preassembled assembly stage for insertion and/or installation into a common built-in housing (not shown). The common built-in housing can in particular be a housing, which has no separating structures, e.g. separating walls, for separating the oven and the microwave. In comparison to FIG. 3, a décor frame has now been disposed on the frame holder, said décor frame comprising ventilation slits (without reference characters) assigned to the lower and upper air guide channels.

The above exemplary embodiment is not to be understood as restrictive. Other support constructions can be used for instance. The invention is also not restricted to a combination of oven and microwave, but can also include other domestic appliances, e.g. two ovens. The invention is also not restricted to a combination of two domestic appliances but can also include more domestic appliances, which are connected to one another accordingly.

### LIST OF REFERENCE CHARACTERS

1 Domestic appliance combination
2 Oven
3 Oven door
4 Panel
5 Gusset plate
6 Side panel
7 Cross arm
8 Lower air baffle
9 Support profile
10 Recess
11 Microwave
12 Lower air guide channel
13 Upper air baffle
14 Upper air guide channel
15 Rear air baffle
16 Bracket
17 Screw-connection points
18 Upper clamping bracket
19 Frame holder
20 Décor frame

1-10. (canceled)

11. A domestic appliance combination comprising at least one first domestic appliance and a second domestic appliance arranged thereabove, which are connected to one another for installation into a common built-in housing, characterized in that
the second domestic appliance is connected to the first domestic appliance by means of a clamp-connection.
